(19) United States
(12) Patent Application Publication
(10) Pub. No.: US 2009/0107153 A1
(43) Pub. Date: Apr. 30, 2009

(54) PRESSURE RELIEF OFFSHORE SYSTEM

(76) Inventors: James Ellis, Lightwater (GB); Patronella Van Emde Boas, Roquebrune Cap-Martin (FR); Hein Wille, Eze (FR)

Correspondence Address: LEON D. ROSEN;FREILICH, HORNBAKER & ROSEN, Suite 1220, 10960 Wilshire Blvd., Los Angeles, CA, 90024, US

(21) Appl. No.: 12/260,570

(22) Filed: Oct. 29, 2008

Related U.S. Application Data
(60) Provisional application No. 60/984,294, filed on Oct. 31, 2007.

(51) Int. Cl. F16L 55/045; F17C 6/00; F17C 13/00; F16L 55/05; F17C 13/04

(52) U.S. Cl. 62/50.7; 62/53.2; 138/30; 137/115.13

(57) ABSTRACT

An offshore hydrocarbon transfer system (10) wherein a conduit (24) connects a floating structure (12) to a second structure (22) to carry hydrocarbons between them, and one of the structures has a shutoff valve (30) that produces a pressure surge in the conduit if the shut-off valve closes too fast. The invention provides a surge protection apparatus (40) with an overflow container (50) that receives hydrocarbons in the event of a pressure surge. The overflow container lies adjacent to the conduit and is connected to the conduit by a pressure relief valve (60). In one apparatus (40), the overflow container lies coaxial with a relief conduit section (42), and includes an elastic outer wall (44) that surrounds the conduit section. In another apparatus, the overflow container (72) lies completely outside the conduit section (42), and can be removed after it has filled with hydrocarbons.

### CROSS-REFERENCE

Applicant claims priority from U.S. Provisional patent application Ser. No. 60/984,294 filed Oct. 31, 2007.

### BACKGROUND OF THE INVENTION

Hydrocarbons such as liquid petroleum, are commonly delivered to a tanker or other carrier through a conduit that connects to a shutoff valve on the carrier. If an emergency situation occurs that requires disconnection of the carrier from the conduit while fluid continues to flow through the conduit, the carrier shuts the valve during a period that is typically set to be 25 seconds to avoid a large pressure surge in the conduit. However, it is possible for the shutoff valve to accidently suddenly close and create a high pressure surge in the conduit. This can happen in the case of a butterfly shutoff valve due to a failure on the spindle of the valve, or if a lockable valve is not properly secured. If such a sudden closing occurs, a pressure spike travels along the conduit away from the carrier, and can cause damage to the conduit and leakage of fluids into the environment. Apparatus that reduced the deleterious effects of a pressure surge, would be of value.

### SUMMARY OF THE INVENTION

In accordance with one embodiment of the invention, a hydrocarbon transfer system is provided for transferring hydrocarbons such as liquid petroleum, through a conduit between a pair of structures that lie in the sea, which reduces the deleterious effects of a pressure surge that occurs in the event that a shutoff valve on one of the structures closes suddenly. Applicant provides an overflow container that lies adjacent to the conduit, or to a first conduit section of the conduit. A relief valve connects the first conduit section to the overflow container. In the event of a pressure surge such as is caused by a sudden closing of the shutoff valve, petroleum flows from the first conduit section through the relief valve into the overflow container.

In one system, the overflow container lies around the first conduit section, so the first conduit section and the overflow container are coaxial. The outside walls of the overflow container can be elastic, so when the relief valve opens and hydrocarbons flow into the container, the outer walls of the container expand to receive a large amount of hydrocarbons.

In another system, the overflow container is radially spaced from the first conduit, so they do not overlap. The opposite ends of the first conduit section and the overflow container are connected together, with the relief valve connected between them. The overflow container can be disconnected from the first conduit section, so if the overflow container fills with hydrocarbons during a pressure surge, the overflow container can be removed and drained at another location and later reconnected.

The novel features of the invention are set forth with particularity in the appended claims. The invention will be best understood from the following description when read in conjunction with the accompanying drawings.

### BRIEF DESCRIPTION OF THE DRAWINGS

FIG. 1 is an isometric view of a hydrocarbon transfer system of one embodiment of the invention.

FIG. 2 is a sectional view of a portion of the conduit of FIG. 1, prior to the occurrence of a pressure surge, where the surge protection apparatus includes an overflow container that lies concentric with a section of the conduit.

FIG. 3 is a view similar to that of FIG. 2, during a pressure surge.

FIG. 4 is a view similar to that of FIG. 3, but showing the removal of fluid from the overflow container after a surge.

FIG. 5 is a sectional view of a portion of a conduit with a surge protection apparatus of another embodiment of the invention prior to the occurrence of a pressure surge, wherein the surge protection apparatus lies at a fixed position spaced radially from a conduit section.

FIG. 6 is a view similar to that of FIG. 5, during a pressure surge.

FIG. 7 is a view similar to that of FIG. 6, after the removal of the overflow container following a surge.

FIG. 8 is a sectional view taken on line 8-8 of FIG. 6

FIG. 9 is a partial side elevation view of a hydrocarbon transfer system of another embodiment of the invention, wherein the overflow container is only loosely coupled to the conduit.

### DESCRIPTION OF THE PREFERRED EMBODIMENTS

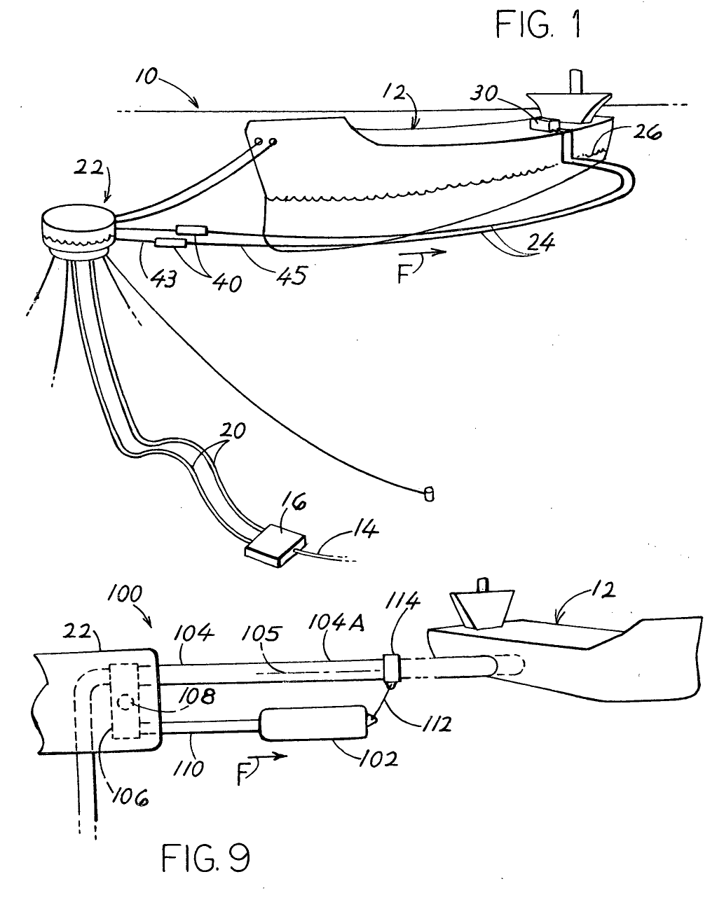

FIG. 1 illustrates a hydrocarbon transfer system 10 wherein hydrocarbons, and especially liquid hydrocarbons or oil, have been produced and are to be transferred to a floating structure 12. The floating structure 12 is a large tanker, or carrier which will carry the oil to a distant location. The oil is pumped along an undersea pipeline 14 through a sea floor platform 16 and subsea hoses 20 to a second structure 22. The second structure is a buoy. The oil then flows along main conduits 24 such as buoyant hoses, to the carrier that floats on the sea surface 26. Two conduits 24 are commonly provided so one can continue to carry oil while the other one is being repaired. Each conduit usually has a plurality of conduit sections connected in series.

At the carrier 12, the conduits 24 connect through shutoff valves 30 to storage tanks on the carrier. The conduits 24 each may have an inside diameter of sixteen inches, to enable a high flow rate so as to fill the carrier in a moderate period of time (e.g. a few days). The shutoff valves 30 are provided to stop the flow of fluid into the carrier before the carrier sails away. Additional valves (not shown) are provided to minimize the spillage of oil into the sea when flow towards the carrier is to stop. The shutoff valves 30 are constructed to close during a period of many seconds, with the time period typically being 25 seconds for a system that includes hoses of a diameter on the order of magnitude of 20 inches. This period is chosen to avoid a pressure surge in the conduits. A pressure surge occurs when oil under pressure (e.g. 50 psi above atmospheric) is flowing forward through a conduit and the oil's path is suddenly blocked (as by a rapidly closed shutoff valve). While additional oil continues to flow forward, the direction of the blocked oil is reversed and there is suddenly a very large amount of oil in the conduit. This results in a pressure surge, which can damage the conduit and valves etc. connected to it. Although the shutoff valve is generally programmed to close during a period of 25 seconds, there are times when the shutoff valve accidently closes suddenly (during a period much less than half the programmed period). This can happen in the case of a butterfly shutoff valve due to a failure on the spindle of the valve, or if a lockable butterfly valve is not properly secured.

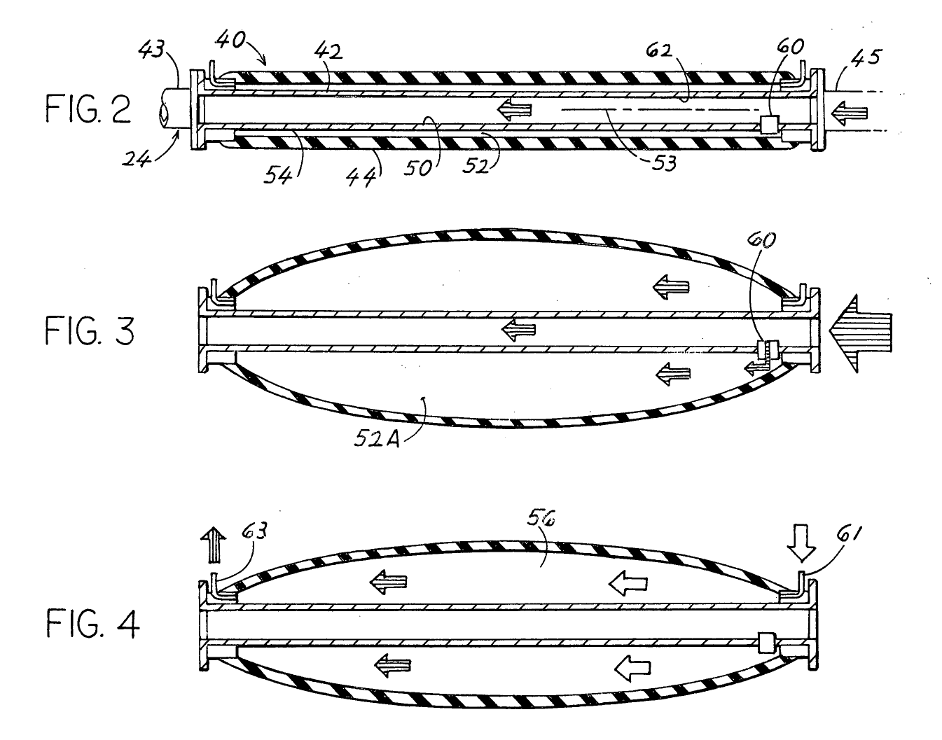

FIG. 2 shows a surge protection apparatus 40 that includes a relief conduit section 42 that is connected in series with first and second conduit sections 43, 45 of one of the conduits 24. While a majority of the conduit 24 is formed by a flexible hose, the particular conduit section 42 is preferably rigid. The apparatus also includes an outer wall 44 forming an overflow container 50 with an overflow chamber 52 that lies between an outside wall 54 of the conduit section 42 and the container outer wall 44. Opposite ends of the overflow container are each mechanically connected to the relief conduit section 42 to mechanically hold them together. The relief conduit section 42 has an axis 53 and the overflow chamber 52 is concentric with the axis. The outer wall 44 of the overflow container is elastic (Young's modulus of elasticity of no more than 50,000 psi). As a result, the volume of the overflow chamber 52 can expand, as to the volume 52A of FIG. 3.

A pressure relief valve 60 connects the passage 62 of the relief conduit section 42 to the overflow chamber 52, so when a pressure surge (e.g. pressure of 75 psi for a system where the oil is intended to be pumped to a pressure of 50 psi) reaches the relief conduit section 42, oil can flow out of the conduit section into the overflow container 50. As pressure-surged oil flows into the overflow chamber 52, the elastic wall expands, so the overflow chamber can hold more oil than the relief conduit section even though its previous volume was less than that of the conduit section. FIG. 4 shows that after the overflow container has received oil, it is necessary to remove the overflow oil 56. This can be done by connecting a source of pressured inert fluid such as water or nitrogen gas to a blowout inlet 60 and receiving the oil in a small tank through a blowout outlet 63. Thereafter, the overflow container 50 is ready for reuse.

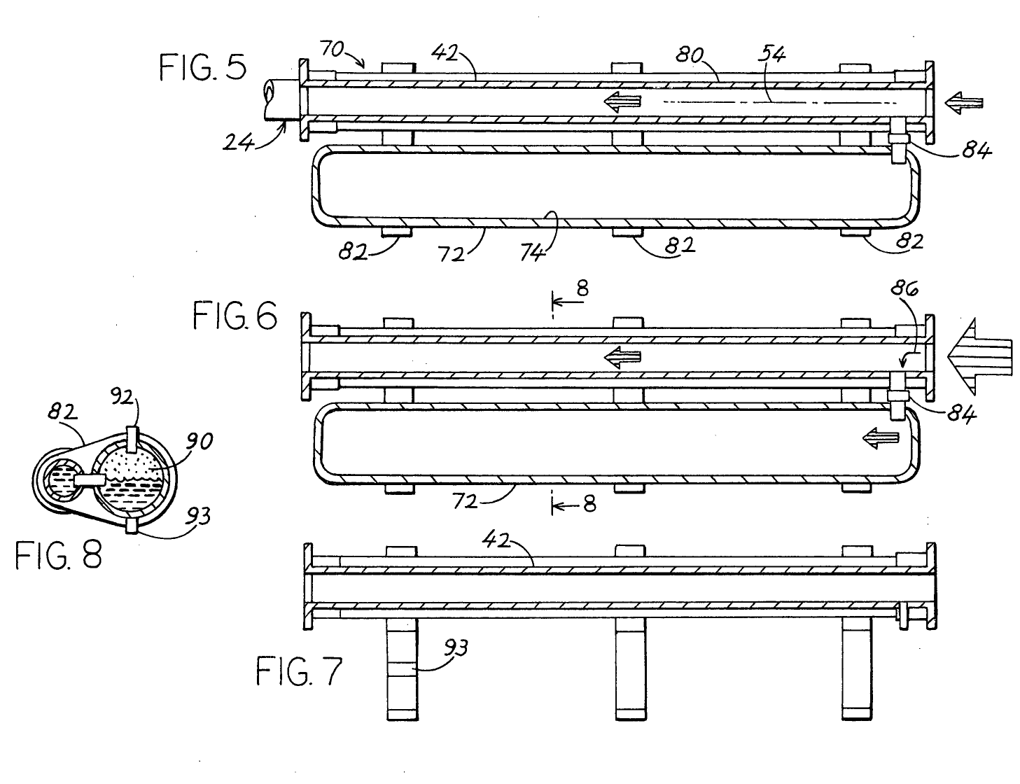

FIG. 5 illustrates another surge protection apparatus 70 that includes an overflow container 72 with a chamber 74 that is radially (with respect to the axis 53 of relief conduit section 42) spaced from the relief conduit section 42. That is, the overflow chamber 74 does not surround the conduit section. Mechanical connectors 82 physically connect the conduit section to the overflow chamber. A pressure relief valve 84 connects the inside of conduit section 42 to the overflow chamber 74. When a pressure surge occurs, oil flows through valve 84 into the overflow chamber to relieve pressure in the conduit. FIG. 6 shows the apparatus during the flow of oil along path 86 into the overflow chamber. FIG. 8 shows that the chamber initially contained a quantity 90 of nitrogen, or some other gas or liquid such as water that is inert to oil. An inert gas is preferred because it flows out of the overflow chamber more readily. A relief valve 92 allows the nitrogen to escape as oil fills the chamber. The mechanical connectors 82 include latches 93 that allow rapid and easy removal and re-attachment of the overflow container (e.g. without welding).

FIG. 7 shows that after oil has flowed into the overflow chamber, the oil can be removed by operating the coupling latches 93 to separate the overflow container 72 from the conduit section 42. Oil in the overflow container can be removed at a more convenient location such as on land or on a vessel. With the pressure relief valve 84 closed (which happens automatically when there is not a surge pressure in the conduit) and an empty (of oil) overflow container in place, the conduit is again ready to carry oil.

FIG. 9 shows a transfer system 100 where an overflow container 102 is connected for fluid flow, to the conduit 104 that carries oil to a carrier 12. The conduit 104, or at least a conduit portion 104A that lies close to the overflow container 104, has an axis 105, and the overflow container is radially spaced from the axis 105. A fluid coupler 106 at the second structure 22 connects the conduit through a relief valve 108 to a tube 110 that extends forward F to the overflow container. Both the conduit 104 and tube 110 float in water. A line 112 (e.g. chain or cable) connects the front end of the overflow container to a pipe clamp 114 on the conduit. An advantage of this arrangement is that a fluid connection to the conduit and to the overflow container, is made and unmade from a location on the second structure 22, instead of requiring such connections and disconnections to be made in the open sea. The use of a line 112 to connect the overflow container to the conduit, allows disconnection and reconnection of the overflow tube front end from the conduit to be made easily.

The drawings which show overflow containers, shows them being elongated and extending primarily parallel (and preferably within 30° of parallel) to the relief conduit section or the conduit. This facilitates handling of the overflow container and conduit, and minimizes drift of the overflow container and its possible rubbing or collision with other elements in the sea.

Thus, the invention provides surge protection apparatuses that each includes an overflow container and relief valve that receives fluid from a main conduit in the event of a pressure surge. One apparatus includes an overflow container that surrounds a relief conduit section of the main conduit, and that may have an expandable chamber to store a considerable amount of the fluid passing through the main conduit. This arrangement enables the overflow container to be handled as part of the conduit. Another apparatus includes an overflow container that is radially spaced from the main conduit so the overflow tube does not surround any part of the main conduit. The overflow container is connected through a latch to the relief conduit section, so the overflow container can be removed from the main conduit for removal of overflow fluid at a more convenient location. Another apparatus includes an overflow container that is fluidly connected to the conduit at the location of a buoy, and with the opposite end of the overflow container only mechanically coupled to the main conduit as through a flexible line.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. A hydrocarbon transfer system which includes a plurality of conduit sections that form an elongated conduit extending between a floating structure that floats at the sea surface and a second structure, where one of said structures has a shut-off valve, including:
an overflow container that lies adjacent to a first of conduit sections;
a relief valve that connects said conduit to said overflow container to pass fluid hydrocarbons from said conduit to said overflow container, said relief valve constructed to open when the pressure of fluid in said conduit exceeds a predetermined level.

2. A system described in claim 1 wherein:
said conduit includes a plurality of series-connected elongated conduit sections including a relief conduit section;
said overflow container is elongated in a direction that is primarily parallel to said relief conduit section, and said overflow container has first and second ends that are each mechanically connected to said first conduit section.

3. A system described in claim 1, wherein:
said overflow container comprises walls forming an annular chamber that surrounds at least a portion of the length of said relief conduit section.

4. The system described in claim 3, wherein:
said walls forming an annular chamber includes a container outer wall that is elastic so it expands as it is filled with fluid.

5. The system described in claim 1 wherein:
said conduit has an axis, said overflow container is radially spaced from said axis, and said overflow container has opposite ends;
said relief valve is flexibly coupled through a flexible hose to a first end of said overflow container to allow limited movement of said overflow container toward and away from said conduit, and including a line that mechanically connects a second of said overflow container to said conduit.

6. A hydrocarbon transfer system that includes first and second structures and a conduit that extends between them and that carries liquid petroleum from said second structure to said first structure, said first structure having a shut-off valve that can stop the flow of petroleum into said first structure, comprising:
an overflow container lying adjacent to said conduit;
a pressure relief valve that connects said conduit to said overflow container, said pressure relief valve constructed to open at a predetermined pressure in said conduit and then flow said liquid petroleum into said overflow container.

7. The system described in claim 6 wherein:
said conduit includes first and second conduit portions and a relief conduit section connected in series with said first and second conduit sections, said overflow container having opposite ends that are mechanically connected to said opposite ends of said relief conduit section, to thereby allow said relief conduit section and said overflow container to be handled together as a unit.

8. The system described in claim 7 wherein:
said overflow container comprises an overflow chamber that extends around said relief conduit section.

9. The system described in claim 7 wherein:
said overflow container has an elastic outer wall that expands when pressure in said overflow chamber increases.

10. The system described in claim 7 wherein:
said overflow container and said relief conduit section are each elongated and extend primarily parallel to each other and are radially spaced apart far enough that they do not overlap, and are connected together by a mechanical connector, and said overflow container is removeable and replaceable on said mechanical connector.

11. The system described in claim 6 including:
a flexible tube that has a tube rear end connected through said relief valve to said conduit and a tube front end connected to a rear end of said overflow container;
a line extending between a front end of said overflow container and said conduit.
